(19) United States
(12) Patent Application Publication
(10) Pub. No.: US 2008/0144167 A1
(43) Pub. Date: Jun. 19, 2008

(54) OPTICAL IMAGING SYSTEM AND METHOD FOR HIGH SPEED AND HIGH RESOLUTION

(75) Inventors: MARK MARSHALL MEYERS, CLIFTON PARK, NY (US); ROBERT JOHN FILKINS, NISKAYUNA, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/609,912

(22) Filed: Dec. 13, 2006

(51) Int. Cl. G02B 21/00

(52) U.S. Cl. 359/368; 359/366

(57) ABSTRACT

An optical imaging apparatus comprising an aspheric objective configured to receive optical radiation from an object and an optical sensing device. The aspheric objective comprises a first reflective aspheric mirror and a second reflective aspheric mirror optically coupled to the first reflective aspheric mirror such that optical radiation received from the object is reflected by the first reflective aspheric mirror to the second reflective aspheric mirror. The optical sensing device disposed adjacent to a non-reflective side of the first aspheric mirror and configured to render digitized images of reflected optical radiation representative of the object.

### BACKGROUND

Embodiments of the invention relate generally to optical imaging systems and more specifically to reflective microscopes with aspheric objectives.

While examining biomedical specimens, it is often required to image dye stained objects or samples with various spectral outputs, such as ultraviolet, deep-blue or near-infrared. Dyes are usually used because various cell structures and objects are more easily observed with the eye once pigmented. Further, the dye molecules can be made to attach to specific sites within a specimen.

Typically, microscopes such as refractive microscopes are usually not configured to transmit ultraviolet or far infrared illumination (due to low glass absorption). In contrast, reflective microscopes have been used to capture images of the object in different spectral regions. However, such reflective microscopes typically have limited field of view for a given amount of resolution due to distortion, field curvature and other off axis aberrations. The limited field of view is a disadvantage when trying to image a large area of specimen or tissue. To overcome the disadvantage of a limited field of view, multiple smaller images of the object with higher levels of overlap are typically captured and then processed to form a single image. This process is typically slow and computationally intensive. The processed image, further, may have inaccuracies due to overlapping sections of the images.

In some instances, reflective microscopes have utilized reflective objectives with a transmissive field flattener between the objective and the sample to extend the field of view. However, such designs often have higher levels of chromatic aberration, and difficulty in transmitting the UV excitation illumination. The design of the reflective elements is strongly affected by the presence of the refractive field flattener in front of the reflective elements, so changing the materials and form of the field flattener to allow use over multiple spectral sources is not practical.

In typical microscope designs, both reflective and refractive, the lenses are constructed in such a way as to allow the simultaneous viewing of specimens by eye and by digital sensor. Further the optical path is arranged in such a way to allow the addition of various optical components (e.g. filter, polarizers, beam splitters). The impact of this approach is often a loss of collected light from the specimen. The loss of light, in turn, leads to a reduction in image signal-to-noise or contrast-to-noise that must be compensated with more illumination power and or longer exposure time on the image sensor. This is a disadvantage in high-speed imaging applications.

Typical microscope objectives do not typically allow for low-loss transmission of ultraviolet and visible light. In certain types of epi-fluorescent imaging, the objective lens must simultaneously create a high-quality visible light image and transmit a light source for the excitation of a fluorescent dye or particle. Refractive microscope objectives are not easily suited to this task if the desired excitation is in the UV spectrum, e.g. 355 nm as used to excite quantum dots particles.

Therefore, there is a need for a microscope with a wide field of view and which is adapted for rapidly imaging an object over multiple spectral ranges at a high resolution.

### BRIEF DESCRIPTION

Briefly, in accordance with one embodiment of the invention, an optical imaging apparatus is provided. The optical imaging apparatus includes an aspheric objective configured to receive optical radiation from an object. The aspheric objective comprises a first reflective aspheric mirror. A second reflective aspheric mirror is optically coupled to the first reflective aspheric mirror such that optical radiation received from the object is reflected by the first reflective aspheric mirror to the second reflective aspheric mirror. The first reflective aspheric mirror and the second reflective aspheric mirror are centered on a single, optical axis. The optical imaging apparatus further includes an optical sensing device disposed adjacent to a non-reflective side of the first aspheric mirror and positioned to receive the optical radiation reflected by the second reflective aspheric mirror and configured to render digitized images of reflected optical radiation representative of the object.

In another embodiment, an optical imaging method is provided. The method comprises receiving optical radiation incident upon a first reflective aspheric mirror and reflecting the optical radiation from the first reflective aspheric mirror to a second reflective aspheric mirror. The first reflective aspheric mirror and the second reflective aspheric mirror are centered on a single, optical axis. The method further comprises reflecting the optical radiation from the second reflective aspheric mirror to an imaging device and rendering digitized images of the optical radiation reflected by the second reflective aspheric mirror.

In another embodiment, a reflective microscope for wide field of view imaging is provided. The reflective microscope comprises a holder for placing an object to be imaged and an aspheric objective configured to receive optical radiation from the object. The aspheric objective comprises a first reflective aspheric mirror and a second reflective aspheric mirror optically coupled to the first reflective aspheric mirror such that optical radiation received from the object is reflected by the first reflective aspheric mirror to the second reflective aspheric mirror. The first reflective aspheric mirror and the second reflective aspheric mirror are centered on a single axis. The reflective microscope further comprises an optical sensing device disposed adjacent to a non-reflective side of the first aspheric mirror and positioned to receive the optical radiation reflected by the second reflective aspheric mirror and configured to render digitized images of reflected optical radiation representative of the object. The reflective microscope also includes a field flattener disposed between the second reflective aspheric mirror and the sensing device such that the optical radiation reflected by the second reflective aspheric mirror is received by the optical sensing device after being transmitted through the field flattening lens and an image processor to receive the digitized images and configured to generate an image of the object.

### DRAWINGS

These and other features, aspects, and advantages of the present invention will become better understood when the following detailed description is read with reference to the accompanying drawings in which like characters represent like parts throughout the drawings, wherein:

FIG. 1 is an exemplary embodiment of an optical imaging apparatus implemented according to one aspect of the invention;

FIG. 2 is a schematic of an exemplary spherical surface and an exemplary aspherical surface;

FIG. 3 is a flow chart of an optical imaging method adapted for wide field of view imaging, implemented according to one aspect of the invention;

FIG. 4 is a ray diagram of an optical imaging apparatus implementing transmissive illumination (or trans-illumination) method for illuminating an object;

FIG. 5 is a ray diagram of an optical imaging apparatus implementing a dark field reflected illumination (or epi-illumination) method for illuminating an object; and

FIG. 6 is a diagrammatic representation of one embodiment of a reflective microscope implemented according to an aspect of the invention.

### DETAILED DESCRIPTION

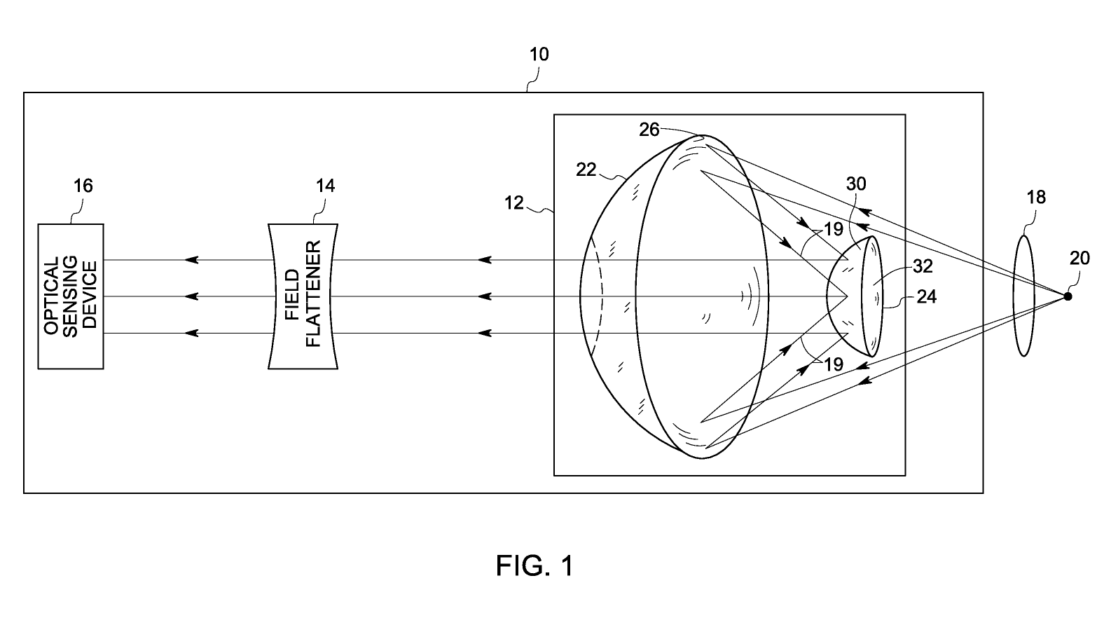

FIG. 1 is an exemplary embodiment of an optical imaging apparatus implemented according to one aspect of the invention. The optical imaging apparatus described herein may be used for various applications including, without limitation, bright field imaging, dark field imaging and fluorescence imaging. As will be described in further detail below, the optical imaging apparatus system 10 comprises an aspheric objective 12, a field flattener 14 and an optical sensing device 16 optically coupled as shown. The aspheric objective 12 is configured to receive optical radiation from an object 20 to be imaged and reflect the optical radiation toward the field flattener 14. The field flattener 14 in turn may refract or reflect the optical radiation before it is received by the optical sensing device 16.

The aspheric objective 12 comprises a first reflective aspheric mirror 22 and a second reflective aspheric mirror 24. The first reflective aspheric mirror 22 comprises a reflective surface 26 and non-reflective surface 28. Similarly, the second reflective aspheric mirror 24 comprises a reflective surface 30 and a non-reflective surface 32. The reflective surface 26 of first reflective aspheric mirror 22 faces the reflective surface 30 of the second reflective aspheric mirror 24.

The first reflective aspheric mirror 22 and the second reflective aspheric mirror 24 are centered on a single optical axis. In one embodiment, the mirrors are diamond turned to provide a surface finish to a precision of about 2-3 nm. In one embodiment, the outside diameters of the two aspheric mirrors are cut on the same machining fixture as the optical surfaces so as to facilitate centering of their respective optical axes. In a specific embodiment, a radius of the first reflective aspheric mirror 22 is greater than the radius of the second reflective aspheric mirror 24. In a specific embodiment, the radius of the first reflective aspheric mirror ranges between 1.9 to 2.2 times the radius of the second reflective aspheric mirror. The use of reflective aspheric mirrors provides a higher level of aberration correction over a wider field of view. In one embodiment, field of view is wider by 40-80% compared to existing refractive microscope objectives.

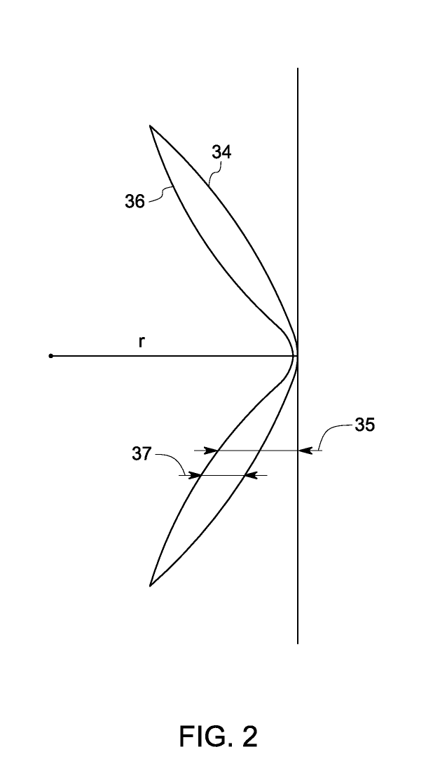

The surfaces of the first and second reflective aspheric mirrors are characterized by curvatures. FIG. 2 is a schematic of an exemplary spherical surface 34 having a first curvature and an exemplary aspherical surface 36 having a second curvature. Surface Sag 35 is defined as the departure 37 of the surface from a plane formed at the vertex of the surface that is orthogonal to the optical axis, i.e., it is the profile that is seen from the side. If the surface is concave, sag is defined as the depth of the surface as a function of the radial distance from the optical axis.

In one embodiment, the curvature of an aspherical surface 36 may be defined by an n^{th} order polynomial. In one embodiment, the curvature of the first and second reflective aspheric surfaces is characterized by a fourth or higher order polynomial. In one embodiment, the curvature of the first and second reflective aspheric surfaces is characterized by a tenth order polynomial with a conic constant. A tenth order polynomial representing the curvature of the first and second reflective aspheric surfaces may be represented by the following equation:

$$Sag ( r ) = \frac{cv \cdot {r}^{2}}{\sqrt{1 + ( K - 1 ) ( 1 - {cv}^{2} {r}^{2} )}} + {ADr}^{4} + {AEr}^{6} + {AFr}^{8} + {AGr}^{10}$$

Continuing with FIG. 1, optical sensing device 16 is disposed behind the non-reflective side 28 of the first aspheric mirror 22 and is positioned to receive the optical radiation reflected by the second reflective aspheric mirror 24 as illustrated. The optical sensing device 16 is configured to render digital images of the object 20. In one embodiment, the optical sensing device includes a charge-coupled device or a CMOS image sensor.

Field flattener 14 is disposed between the non-reflective side 28 of the first reflective aspheric mirror 22 and the optical sensing device 16. In the illustrated embodiment, the field flattener 14 is a refractive field flattener and is disposed such that the optical radiation reflected by the second reflective aspheric mirror 24 is received by the optical sensing device 16 through the field flattener. The field flattener is designed in accordance with the optical sensing device being used. As the field flattener is an achromatic doublet, which substantially reduces variation in focal length with wavelength. The aberrations in the visible range are reduced by bringing the red light and blue light focus to the same plane, whereas normally the best focus for the red, green and blue are linearly displaced along the optical axis. In one embodiment, the distortion is about 0.5%.

In one embodiment, the field flattener 14 may comprise a concave lens and a convex lens coupled together. In one embodiment, the concave lens has a high Abbe number and low dispersion. The convex lens, on the other hand has a low Abbe number and high dispersion. As is well known, the Abbe number of a transparent material is a measure of the material's dispersion or a measure of variation of refractive index with wavelength. For one embodiment in the visible wavelength range, the lenses are formed with Schott BK7 (refractive index 1.517, Abbe number 64.2 (low dispersion negative element)), Schott F2 (refractive index 1.620, Abbe number 36.4 (high dispersion positive element)) optical glass. For the infrared wavelength range the relevant materials include Silica and Germanium. For the ultraviolet wavelength range the relevant materials include fused silica and calcium fluoride. In other embodiments, a reflective field flattener may be used in place of a refractive field flattener. The reflective field flattener can operate over the ultraviolet wavelength, visible wavelength and the infrared wavelength.

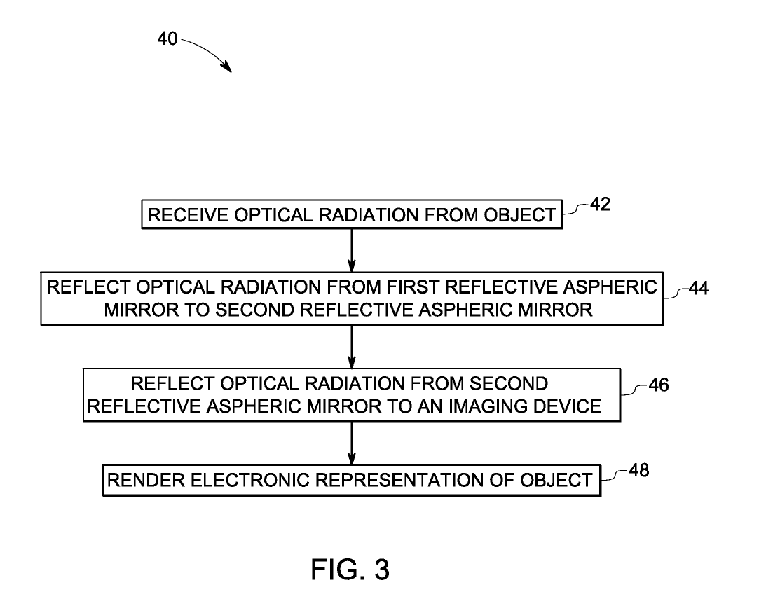

FIG. 3 is a flow chart of an optical imaging method adapted for wide field of view imaging, implemented according to one aspect of the invention. The imaging method described below may be implemented in various optical imaging systems such as the optical imaging system described above. The method comprises several steps, each of which is described in further detail below.

In the illustrated method, optical radiation from an object is received by a first reflective aspheric mirror such as reflective aspheric mirror 26 at block 42. The optical radiation may be received by either transmissively illuminating the object or by reflectively illuminating the object. An imaging apparatus using a bottom-illuminated object is defined as a tranmissive illumination system. An imaging apparatus using a top illuminated object is defined as a reflected illumination. At block 44, the optical radiation from the first reflective aspheric mirror is reflected to a second reflective aspheric mirror such as reflective aspheric mirror 24.

At block 46, the optical radiation is reflected from the second reflective aspheric surface and is transmitted to an imaging device such as optical sensing device 16. In a further embodiment, the optical radiation reflected by the second reflective aspheric mirror is transformed into a flatter image with the field flattener lens before being transmitted to the image sensor. In one embodiment, the optical radiation is flattened using an achromatic field flattener such as field flattener 14.

Finally, in block 48, digitized images of the object are rendered using the optical radiation reflected by the second reflective aspheric mirror and transmitted to the image sensor. In one embodiment, the rendering is performed using an optical sensing device.

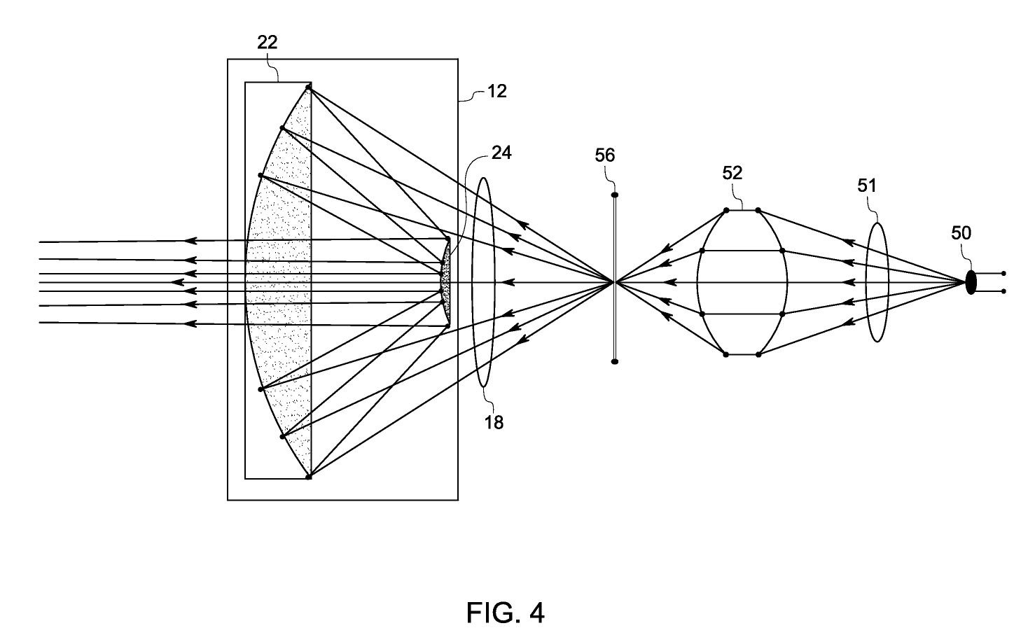

In one embodiment, the optical radiation is received by transmissively illuminating the object as shown in FIG. 4. As used herein, transmissively illuminating refers to a method of illumination where light completely passes through the object before being imaged. Light 51 emitted from filament 50 is focused onto the object through an Abbe illumination system 52, with a high numerical aperture condenser system. In alternate embodiments, light is conducted through a waveguide or produced by an LED. Holder 56 (on which the object is placed) is located at the focus of the condenser lens and at the focus of the aspheric objective 12. The optical radiation 18 is received by the aspheric objective.

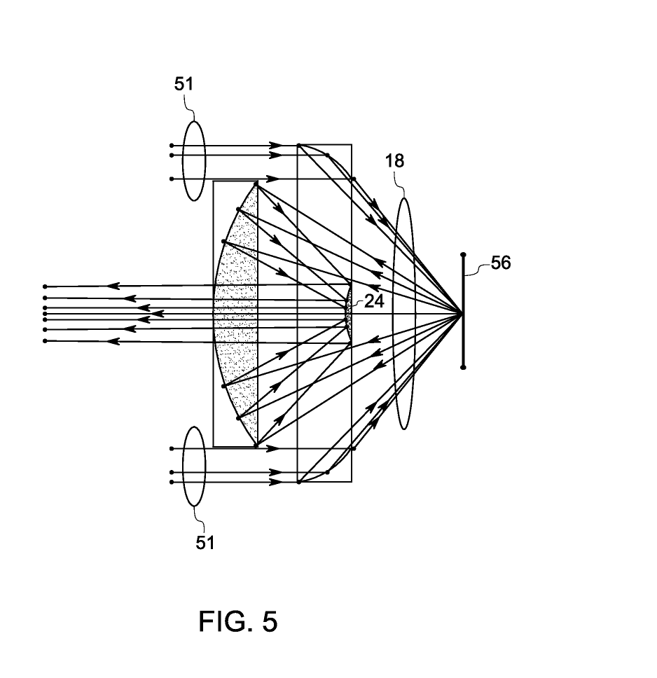

In another embodiment, the optical radiation is received by a dark field reflected illumination (or epi-illumination) as shown in FIG. 5. Light 51 is emitted from a source that is disposed above the object and focused by a reflector 58 onto the object placed on holder 56. Such systems implementing such illumination techniques are defined as dark field imaging systems since the light is incident from outside the acceptance angle of the objective 12. That is, light is emitted from a ring that would not be seen with the objective unless there is scattering in the sample to redirect the light up into the objective.

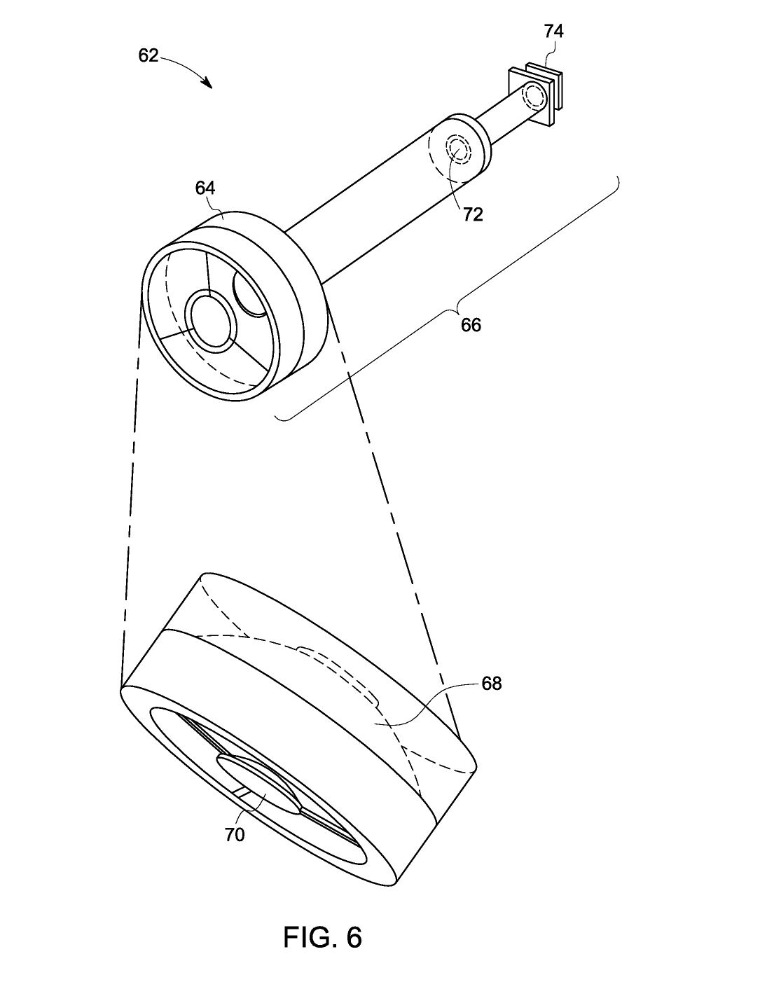

FIG. 6 is a diagrammatic representation of one embodiment of a reflective microscope for wide field of view imaging implemented according to an aspect of the invention. In the illustrated embodiment, the length of the microscope is about 340 millimeters and the diameter of the microscope is about 120 millimeters. However, embodiments of the present invention may be incorporated in reflective microscopes having different form factors and dimensions.

The reflective microscope 62 comprises aspheric objective 64 and image side tube 66. Each component is described in further detail below. A holder (not shown) is provided for retaining an object for microscopic imaging. The holder is typically disposed adjacent to objective 64. The distance between the holder and the objective is generally referred to as working distance. In one embodiment, the working distance of the reflective microscope is greater than 5 millimeters. In a more specific embodiment, is the working distance is about 55 millimeters.

The aspheric objective 64 is configured to receive optical radiation from the object to be imaged. The aspheric objective 64 comprises a first reflective aspheric mirror 68 and a second reflective aspheric mirror 70. The first and second reflective aspheric mirrors are implemented similar to the techniques described in FIG. 1.

Image side tube 66 houses the field flattener 72 and the optical sensing device 74. The field flattener comprises a reflective field flattener or a refractive field flattener. The reflective microscope is designed such that a user may place the desired type of field flattener within the image side tube based on the object being examined.

In one embodiment, the length of the image side tube is about 319 mm. In another embodiment, the distance between the field flattener and the objective is about 231 mm and the distance between the field flattener and the optical sensing device is about 83 mm. The image side tube may further include an image processor (not shown) to receive the digitized images and configured to generate an image of the object, which can be viewed on a display device (not shown).

The embodiments described above have many advantages including the ability to operate in multiple spectral ranges by using the aspheric reflective mirrors. By using the aspheric reflective mirrors, it is possible to eliminate the need for a large number of refractive lenses in a microscope. Thus, by changing the illumination configuration, the microscope may be used for bright field imaging, dark field imaging and fluorescence imaging. By using a field flattener in conjunction with the aspheric reflective surfaces, high resolution images with a wider field of view can be obtained.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An optical imaging apparatus comprising:
an aspheric objective configured to receive optical radiation from an object comprising:
a first reflective aspheric mirror, and
a second reflective aspheric mirror optically coupled to the first reflective aspheric mirror such that optical radiation received from the object is reflected by the first reflective aspheric mirror to the second reflective aspheric mirror; wherein the first reflective aspheric mirror and the second reflective aspheric mirror are centered on a single optical axis; and
an optical sensing device disposed adjacent to a non-reflective side of the first aspheric mirror and positioned to receive the optical radiation reflected by the second reflective aspheric mirror and configured to render digitized images of reflected optical radiation representative of the object.

2. The apparatus of claim 1, further comprising a field flattener disposed between the non-reflective side of the first reflective aspheric mirror and the sensing device such that the optical radiation reflected by the second reflective aspheric mirror is received by the optical sensing device through the field flattener.

3. The apparatus of claim 2, wherein the field flattener further comprises a concave lens and a convex lens coupled together and is configured to achromatize light from the visible wavelength region.

4. The apparatus of claim 2, wherein the field flattener comprises a refractive field flattener.

5. The apparatus of claim 2, wherein the field flattener comprises a reflective field flattener.

6. The apparatus of claim 1, wherein the curvature of at least one of the first reflective aspheric mirror and the second reflective aspheric mirror is characterized by at least a fourth order polynomial.

7. The apparatus of claim 1, wherein a radius of the first reflective aspheric mirror is greater than the radius of the second reflective aspheric mirror.

8. The apparatus of claim 1 where the ratio of the radii of curvature for the first to second mirror is between about 1.9 and about 2.2.

9. The apparatus of claim 1, wherein the apparatus is adapted for use in bright field imaging, dark field imaging, phase contrast imaging and fluorescence imaging.

10. The apparatus of claim 1, wherein the optical sensing device comprises a charge-coupled device, photodiode, photomultiplier or a CMOS imager.

11. The apparatus of claim 1, further comprising a cylindrical housing enclosing the aspheric objective and the optical sensing device.

12. An optical imaging method comprising:
receiving optical radiation incident upon a first reflective aspheric mirror;
reflecting the optical radiation from the first reflective aspheric mirror to a second reflective aspheric mirror; wherein the first reflective aspheric mirror and the second reflective aspheric mirror are centered on a single optical axis;
reflecting the optical radiation from the second reflective aspheric mirror to an imaging device; and
rendering digitized images of the optical radiation reflected by the second reflective aspheric mirror.

13. The method of claim 12, wherein the receiving optical radiation comprises transmissive-illumination or reflective-illumination.

14. The method of claim 12, wherein the received optical radiation is adapted for use in bright field imaging, dark field imaging, phase contrast imaging and fluorescence imaging.

15. The method of claim 12, further comprising collimating the optical radiation reflected by the second reflective aspheric mirror to form an infinity corrected objective.

16. The method of claim 12, wherein the curvature of at least one of the first reflective aspheric mirror and the second reflective aspheric mirrors is characterized by a fourth or higher order polynomial.

17. The method of claim 12, wherein a radius of the first reflective aspheric mirror is greater than the radius of the second reflective aspheric mirror.

18. The method of claim 12, wherein the rendering is performed using an optical sensing device.

19. The method of claim 18, further comprising disposing the optical sensing device adjacent to a non-reflective side of the first reflective aspheric mirror.

20. A reflective microscope for wide field view imaging, the reflective microscope comprising:
a holder for placing an object to be imaged;
an aspheric objective configured to receive optical radiation from the object comprising:
a first reflective aspheric mirror, and
a second reflective aspheric mirror optically coupled to the first reflective aspheric mirror such that optical radiation received from the object is reflected by the first reflective aspheric mirror to the second reflective aspheric mirror; wherein the first reflective aspheric mirror and the second reflective aspheric mirror is centered on a single optical axis;
an optical sensing device disposed adjacent to a non-reflective side of the first aspheric mirror and positioned to receive the optical radiation reflected by the second reflective aspheric mirror and configured to render digitized images of reflected optical radiation representative of the object;
a field flattener disposed between the first reflective aspheric mirror and the sensing device such that the optical radiation reflected by the second reflective aspheric mirror is received by the optical sensing device via the field flattener; and
an image processor to receive the digitized images and configured to generate an image of the object.

21. The reflective microscope of claim 20, wherein the field flattener further comprises a concave lens and a convex lens fused together.

22. The reflective microscope of claim 20, wherein the field flattener comprises a refractive field flattener.

23. The reflective microscope of claim 20, wherein the field flattener comprises a reflective field flattener.

24. The reflective microscope of claim 20, wherein the curvature of at least one of the first reflective aspheric mirror and the second reflective aspheric mirrors is characterized by a fourth or higher order polynomial.

25. The reflective microscope of claim 20, wherein a radius of the first reflective aspheric mirror is greater than the radius of the second reflective aspheric mirror.

26. The reflective microscope of claim 20, wherein a working distance of the reflective microscope is greater than 25 millimeters.

27. The reflective microscope of claim 20, wherein the optical radiation comprises transmissive-illumination or reflective-illumination.

28. The reflective microscope of claim 20, wherein the received optical radiation is adapted for use in bright field imaging, dark field imaging, phase contrast imaging and fluorescence imaging.
